(19) United States
(12) Patent Application Publication
(10) Pub. No.: US 2007/0228239 A1
(43) Pub. Date: Oct. 4, 2007

(54) DEVICE AND METHOD FOR MOUNTING A GAUGE IN A VEHICLE

(75) Inventor: Calvin Samuel Eng, Morristown, NJ (US)

Correspondence Address: KNOBBE MARTENS OLSON & BEAR LLP, 2040 MAIN STREET, FOURTEENTH FLOOR, IRVINE, CA, 92614, US

(73) Assignee: Auto-Tech Interiors, Inc., Irvine, CA (US)

(21) Appl. No.: 11/694,749

(22) Filed: Mar. 30, 2007

Related U.S. Application Data
(60) Provisional application No. 60/787,672, filed on Mar. 30, 2006.

(51) Int. Cl. G12B 9/00; A47F 5/00

(52) U.S. Cl. 248/288.31; 248/27.1

(57) ABSTRACT

A device for mounting and displaying a gauge or other display, such as gauges of a vehicle, includes a base portion and one or more cups secured to the base portion. The base portion of the device can be configured to attach to one or more surfaces of the vehicle. The cups can be configured to be selectively rotated and/or otherwise positioned to achieve the desired display of the gauge.

### PRIORITY INFORMATION

This application claims priority to U.S. Provisional Application Ser. No. 60/787,672, filed Mar. 30, 2006, the entirety of which is herein incorporated by reference.

### BACKGROUND

1. Field of the Inventions

The present inventions relate to a mounting device attachable to a vehicle. Specifically, the present inventions relate to an improved gauge-mounting device that secures to a surface of the vehicle's existing structure. Further, the device can provide for dynamic adjustment of a position of a gauge mounted thereon.

2. Description of the Related Art

In the aftermarket of the vehicle industry, vehicles such as automobiles are modified to include additional instrumentation to measure parameters related to the vehicle's performance. The measurements or readings performed by these instruments are displayed using gauges, which may measure a variety of parameters related to the performance of the vehicle, such as, for example, the vehicle's fuel pressure and the like.

Typically, the vehicle is fitted with a mounting apparatus to hold these gauges so that displayed information may be communicated to and accessed by an interested viewer, such as the vehicle's operator, a passenger or a mechanic. A conventional mounting apparatus is a static “pod” that is fixedly secured to a base member. According to this conventional apparatus, a gauge is installed in the pod such that the gauge's position is fixed and may not be adjusted in any way to adapt to a viewer's visual perspective. However, different viewers may have different primary lines of sight. As such, gauges installed in statically positioned pods are difficult for viewers to view.

Accordingly, there exists a need in the art for a mounting solution that provides an easy, safe and efficient display of a gauge in a vehicle, while permitting a quick and simple means of adjusting the position of that gauge.

### SUMMARY OF THE INVENTIONS

The present invention relates to a versatile “mounting solution” device that provides safe and easy access to information displayed by a gauge in a vehicle, including, but not limited to cars, motorcycles, trucks, bicycles, ATVs, mopeds, motor boats, wave runners, etc. Moreover, the present invention relates to a pod device with a base mountable in a vehicle. Attached to the base is a housing that is adapted to accept and securely house a gauge. The position of the housing can be dynamically rotated, tilted, adjusted, or moved at the discretion of the viewer. In addition, the position of the housing may be secured in a fixed position if desired by the viewer.

In an embodiment of the invention, the housing may be adapted to securely fit any standard-sized gauge. Advantageously, the position of the housing may be adjusted to allow for the gauge instrument information to be displayed to any viewer's line of sight or viewing angle. As such, the information displayed by the gauge may be viewed from any position in the vehicle. The cup may be freely rotated, moved and tilted to provide a safe and convenient display of the gauge to the driver or to another occupant of the vehicle. The device provides an easily adjustable gauge display that allows the viewer to adjust the angle of the gauge for optimal viewing.

In one embodiment of the invention, a device for mounting a gauge in a vehicle comprises a base portion mountable to at least one surface in the vehicle and a housing coupled to the base portion. The housing is selectively positionable according to a viewer's preference and is adapted to securely house a gauge. In another embodiment, the housing includes an adjustable ball joint. In yet another embodiment, the ball joint is attached at an end of a stem extending from a bottom portion of the cup. In one embodiment, the base includes a ball joint housing adapted to encase the ball joint such that the ball joint is free to rotate within the ball joint housing.

In some embodiments of the invention, the ball joint housing includes a vice for tightening and loosening the ball joint housing. In yet other embodiments, the ball joint housing includes a capsule, such that movement of the vice causes the capsule to move into and out of contact with the ball joint, providing an adjustable degree of frictional force to the ball joint. In another embodiment, an interior surface of the housing includes a plurality of raised portions adapted to securely engage a gauge inserted within the cup. In one embodiment, the device further comprises a fitment sleeve which is adapted to fit the housing and which allows the housing to secure gauges having varying tolerances. In one embodiment, an exterior surface of the fitment sleeve includes a plurality of raised portions adapted to align with the slots of the housing, such that upon proper alignment, the fitment sleeve fits securely within the housing.

In one embodiment of the invention, the housing of the device includes a cable feed slot for passage of one or more gauge cables. In another embodiment, the base portion includes one or more cable drop zones for passage of gauge cables. In yet another embodiment, the housing includes a perforated rear wall delineating one or more removable sections. In some embodiments, the housing is rotatable through 360 degrees. In another embodiment, the housing is adapted to tilt.

In some embodiments, the device further comprises a conversion sleeve adapted to fit within the housing, wherein the conversion sleeve allows the housing to secure a gauge of a smaller size than an originally intended gauge size. In another embodiment of the invention, an interior surface of the conversion sleeve includes a plurality of raised portions adapted to securely engage a gauge inserted within the conversion sleeve. In one embodiment, the base portion is mountable to the at least one surface in the vehicle using at least one mechanical fastener. In yet another embodiment, the base portion is mountable to the dashboard area of the vehicle.

In some embodiments of the invention, a method for displaying information in a vehicle is disclosed. The method comprises the steps of securing a gauge for displaying vehicle information within a mounting device and directly securing the mounting device on surface of the vehicle. In another embodiment, securing the mounting device on a surface of the vehicle comprises passing one or more threaded fasteners through openings of the mounting device to engage the surface of the vehicle. In one embodiment, the method further comprises adjusting the position of the gauge secured within the mounting device by manipulating one or more joints of the mounting device. In yet another embodiment, the position of the gauge is adjusted by loosening and tightening a ball joint.

### BRIEF DESCRIPTION OF THE DRAWINGS

The present inventions will be more readily understood from the detailed description of the preferred embodiments presented below, considered in conjunction with the attached drawings, of which:

FIG. 1 is a perspective view of a pod device, according to one embodiment;

FIG. 2 is a perspective rear view of a base of a pod device, according to one embodiment;

FIG. 3 is a front view of a pod device, according to one embodiment;

FIG. 4 is a rear view of a pod device, according to one embodiment;

FIG. 5 is a side view of a cup with a ball joint partially encased by a base piece of a ball joint housing, according to some embodiments;

FIG. 6 is a side view of a cup with a ball joint partially encased by a joining piece of a ball joint housing, according to some embodiments;

FIG. 7 is a side view of a cup with a ball joint fully encased in a ball joint housing, according to some embodiments;

FIG. 8 is a rear view of a cup with a ball joint partially encased by a base piece having a capsule, according to one embodiment;

FIG. 8A shows an exemplary hex key for controlling a vice of a ball joint housing, according to one embodiment;

FIG. 8B shows an exemplary hex key operating a vice of a ball joint housing, according to one embodiment;

FIG. 8C shows a side view of a pod device, according to one embodiment;

FIG. 9 is a rear view of a cup with a conversion sleeve fitted therein, and the conversion sleeve with the cup cut away, according to one embodiment;

FIG. 10 shows exemplary fitment sleeves and conversion sleeves, according to some embodiments;

FIG. 11 is a front perspective view of a gauge mounting device coupled to a mounting surface, according to some embodiments;

FIG. 12 is a front view of the gauge mounting device of FIG. 11 without the mounting surface;

FIG. 13 is a side view of the gauge mounting device of FIG. 12;

FIG. 14 is a front perspective view of a gauge mounting device of FIG. 12; and

FIG. 15 is a front cross-sectional view of the gauge mounting device of FIG. 12; showing a ball joint partially encased within a ball joint housing.

It is to be understood that the attached drawings are for the purpose of illustrating concepts of the present invention and may not be to scale.

### DETAILED DESCRIPTION OF THE PREFERRED EMBODIMENTS

The present inventions relate to a pod device for mounting one or more gauges in a vehicle (e.g., automobile, bicycle, motorcycle, truck, boat, train, airplane, etc.). Additional details and embodiments of the pod device and the various features and components associated with it can be found in U.S. patent application Ser. No. 11/137,280, filed on May 25, 2005 and published as U.S. Publication No. 2006/01455075, the entirety of which is hereby incorporated by reference herein.

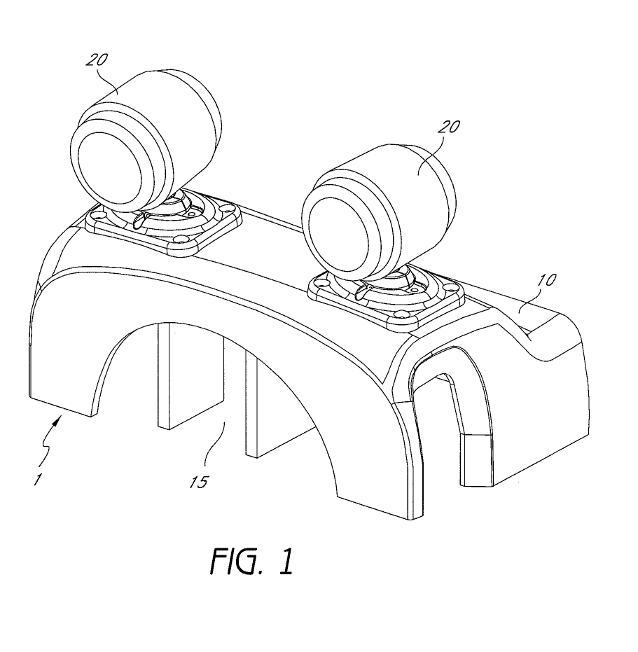

FIG. 1 illustrates an exemplary pod device 1 according to one embodiment of the present inventions. As shown, the pod device 1 can include a base 10 and one or more cups 20. In some embodiments, the base 10 includes one or more tabs 15 designed to allow for a direct fit of the pod device 1 in place of an original equipment part of the vehicle. As such, the pod device 1 can be referred to as a “direct fit replacement” of the vehicle's original equipment. In some embodiments, the tabs 15 are sized and arranged to complement and align with the original equipment of the vehicle such that the pod device 1 may integrate with the original structure of the vehicle.

According to some embodiments, the pod device 1 is adapted to directly replace the vehicle's steering column cover. For example, to install the pod device 1 in a vehicle, the installer can remove the original steering column cover and replace it with the pod device 1. Other vehicle parts that may be replaced with a pod device similar to the pod device 1 include but are not limited to a speaker grill, a clock, a dashboard or the like. It will be appreciated that other methods and devices can be used to install the pod device 1 to the vehicle.

Typically, different vehicle makes and models have different steering column structures, dimensions, shapes, sizes, configurations and/or other characteristics. Accordingly, the shape and dimensions of the base 10 may be customized to directly fit any vehicle type. Optionally, the base 10 may be treated and texture coated to match the specifications of the vehicle's original equipment to integrate with the “look and feel” of the vehicle. The base 10 may be composed of any suitable material, including but not limited to, a material of the original part of the vehicle that the base 10 is replacing. In some preferred embodiments, the base 10 is composed of an acrylonitrile-butadiene-styrene (ABS) plastic, a polypropylene plastic and/or the like.

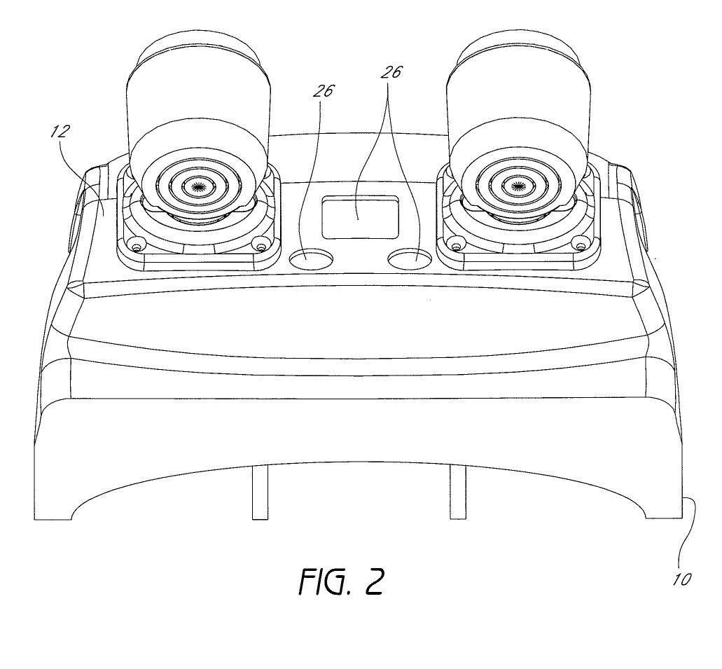

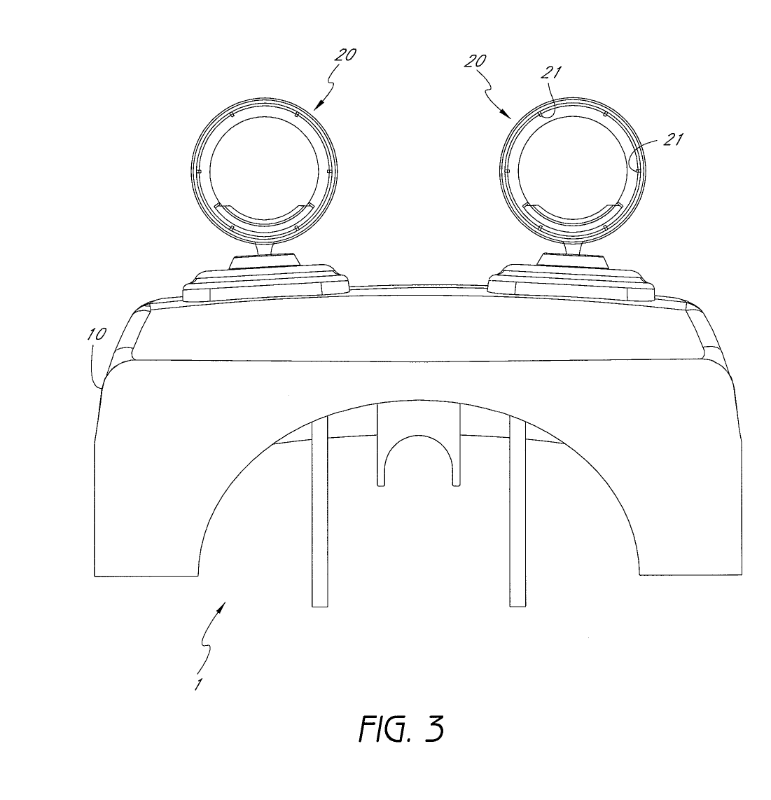

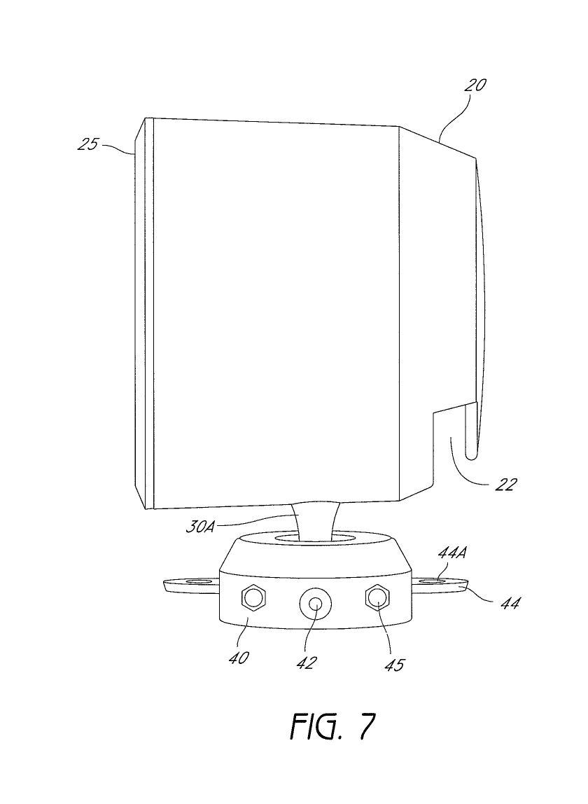

In some embodiments of the inventions, the pod device 1 also includes one or more cups 20 adapted to attach to the base 10, as shown in FIG. 3. The cup 20 can be a housing unit adapted to hold a display or other instrumentation, such as, for example, a gauge. As shown in FIG. 2, the base 10 can include an integration area 12 where the cup 20 is attached. The cup 20 may be secured within the integration area 12 via any known securing mechanism, such as, for example, a conventional screw and nut arrangement. In some preferred embodiments, the cup 20 is first encased in a ball joint housing 40 (shown, for example, in FIG. 7), which in turn is secured to the integration area 12 of the base 10, as described in detail below. In some embodiments, the cup 20 may be composed of an ABS plastic or any other material.

According to some embodiments, the cup 20 includes a front opening for accepting a gauge. Although the present invention is described in terms of certain preferred embodiments of the inventions wherein the pod device 1 includes two cups 20, one having ordinary skill in the art will appreciate that the pod device 1 may include any number of cups 20, including more or fewer than two cups 20.

In one embodiment, the cup 20 includes a plurality of raised ribs or slots 21 spaced apart along the interior surface of the cup 20, as shown in FIG. 3. The raised slots 21 can be integral to the interior surface of the cup 20 and provide friction against the surface of an object fitted within the cup 20, such as a gauge, a fitment sleeve 25 (described in detail below), a conversion sleeve 50 (described in detail below) and/or the like.

The opening and internal housing of the cup 20 may be dimensioned to accept and securely hold a gauge of any size. In some embodiments, the cup 20 is sized to securely house a standard 52 mm diameter gauge or a standard 60 mm diameter gauge. However, the cup 20 can be alternatively configured to securely house gauges having different shapes, sizes, dimensions and/or other characteristics. In addition, it will be appreciated that the cup 20 can be configured to house non-standard gauges, either in addition to or in lieu of standard gauges.

Because the dimensions of standard-sized gauges (e.g., 52 mm gauges, 60 mm gauges, etc.) may include varying tolerances from manufacturer to manufacturer, the cup 20 can be advantageously fitted with a fitment sleeve 25. In some embodiments, the fitment sleeve 25 is adapted to securely fit within the cup 20. Once fitted in the cup 20, the fitment sleeve 25 can provide sufficient friction to the gauge to enable the securing of gauges of varying dimensional tolerances. The fitment sleeve 25 may be composed of any compressible material, such as rubber, foam, etc. In certain preferred embodiments, the fitment sleeve 25 is composed of one or more rubber or other compressible materials.

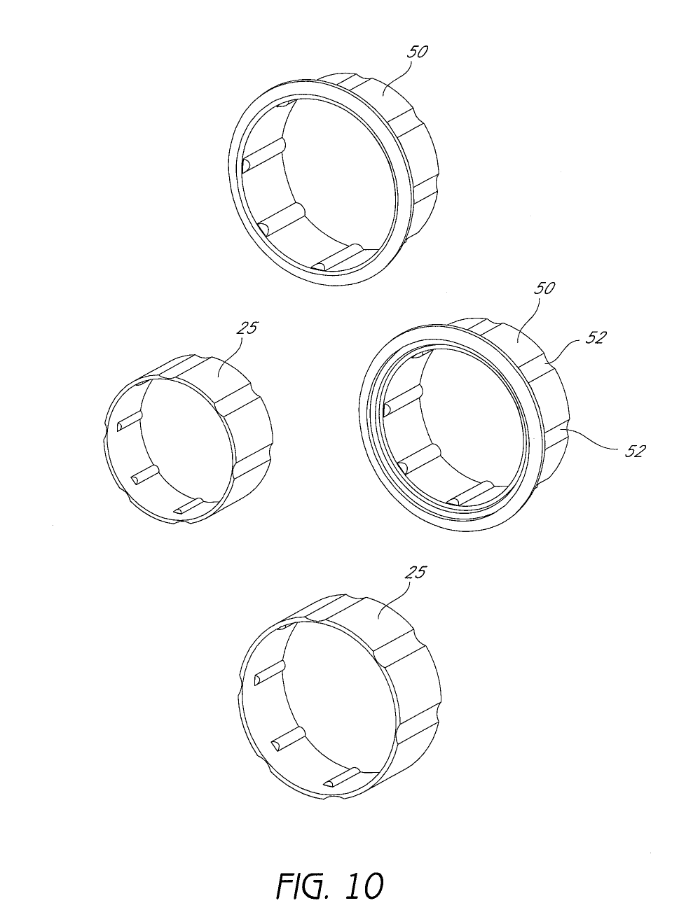

In one embodiment, a portion of the fitment sleeve 25 to be inserted into the cup 20 includes a textured outer surface. The outer surface can include a plurality of raised and sunken ridges or slots (shown in FIG. 10) adapted to align with the raised slots 21 of the cup 20 such that, upon proper alignment, the fitment sleeve 25 securely fits within the cup 20.

In addition, the inner surface of the portion of the fitment sleeve 25 inserted into the cup 20 may include a plurality of raised ribs or slots. These raised slots function much like the raised slots 21 arranged on the interior surface of the cup 20, providing friction against the gauge and enabling a secure fit of the gauge within the fitment sleeve 25.

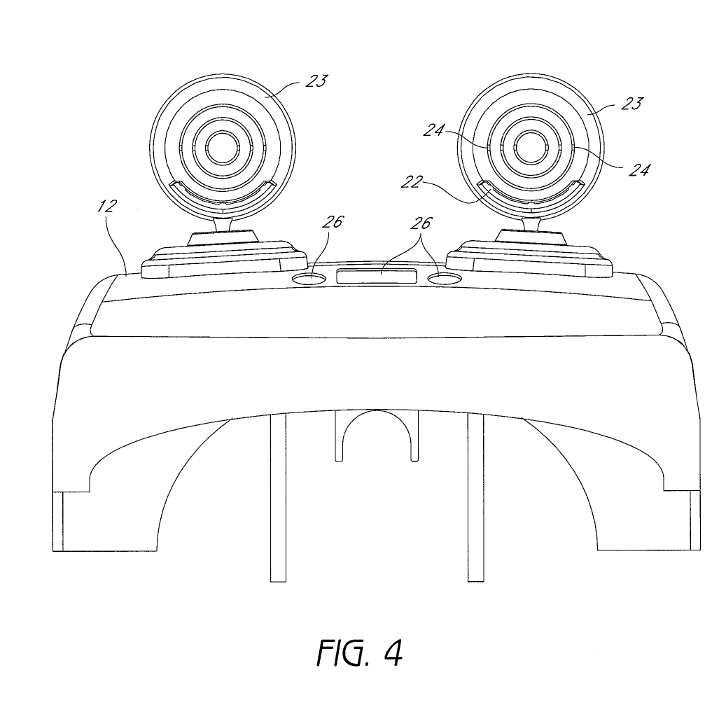

FIG. 4 depicts a rear perspective of the pod device 1 according to an embodiment of the present inventions. The rear of the cup 20 includes a cable feed slot 22 to allow for the passage of any number or size of cables, vacuum lines or other attachments to the gauge (collectively referred to as “cables”). In a preferred embodiment, the cable feed slot 22 is located at the bottom of the rear surface of the cup 20 (i.e., the end of the cup 20 attached to the base 10).

In some embodiments, a portion of the rear wall of the cup 20 may be perforated such that the wall includes a number of individual removable sections 23. In its original form, the cup 20 can include a number of sections 23 connected together by one or more connection tabs 24. The sections 23 may be removed or “punched out” to increase the size of the rear opening to accommodate gauges having different sizes and shapes which may protrude beyond the rear surface of the cup 20. For example, mechanical gauges often include a nozzle at the rear of the gauge extending beyond the rear of the cup 20. As such, one or more of the sections 23 may be punched out to allow the nozzle to extend out the rear of the cup 20. Optionally, depending on the position of the cables of a gauge to be fitted in the cup 20, the cables may extend through one or more sections 23 of the cup 20. In a preferred embodiment, one or more sections 23 may be removed by breaking the connection tabs 24 that connect the section 23 to be removed to an adjacent section 23. One of ordinary skill in the art will appreciate that any shape, size and/or quantity of sections may be used.

In some embodiments, the gauge cables fed through the cable feed slot 22 or through openings created by removing one or more sections 23 are routed through one or more cable drop zones 26 located in the base 10. Advantageously, the cables that run through the cable drop zone 26 may be passed internally through the vehicle's dashboard and hidden from sight.

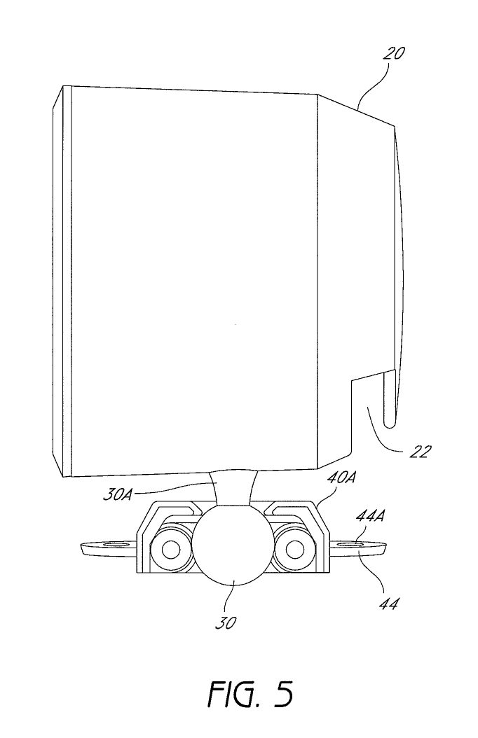

FIG. 5 shows a side view of the cup 20 according to an embodiment of the present inventions. In one arrangement, a ball joint 30 is located at an end of a stem 30A extending from the bottom side of the cup 20. One having ordinary skill in the art will appreciate that although some embodiments of the present inventions include a ball joint 30 having a stem 30A, the ball joint 30 may be alternatively connected directly to the bottom side of the cup 20.

In one embodiment, the ball joint 30 and the stem 30A are integral components of the cup 20 (e.g., the cup 20, the stem 30A and the ball joint 30 are machined or formed as one piece). However, alternative arrangements are also contemplated, including but not limited to, a separate composite piece, comprising a stem 30A and ball joint 30, which is attachable to the cup 20.

The ball joint 30 can be adapted to fit within a ball joint housing 40 (e.g., FIG. 7). When in its non-fixed position within the ball joint housing 40, the ball joint 30 can be rotated to allow the cup 20 to rotate, swivel and/or tilt in any direction. In some embodiments, the ball joint 30 is preferably configured to provide a wide range of motion and allow an operator to adjust the rotation angle and tilt of each cup 20 independently of the one or more other cups 20 of the pod device 1. In some embodiments, the cup 20 can be rotated freely (e.g., 360 degrees), without limitation. However, in other embodiments, the extent to which the cup 20 can be rotated can be less than 360 degrees. Further, the cup 20 may be tilted in any manner desired, limited only by the physical structure of the pod device 1. Optionally, the ball joint housing 40 can be configured to enable the ball joint 30 a limited amount of lateral movement when in the non-fixed position. In some embodiments, movement of the cup position may be hand adjusted. Further, fine adjustments to the position of the cup 20 may be made by an operator. Although some embodiments of the cup 20 include a stem 30A with a ball-shaped joint at the end adapted to be encased in a ball joint housing 40, one having ordinary skill in the art will appreciate that any type and shape joint arrangement may be used, with an important consideration being that the arrangement allows the cup 20 to move freely.

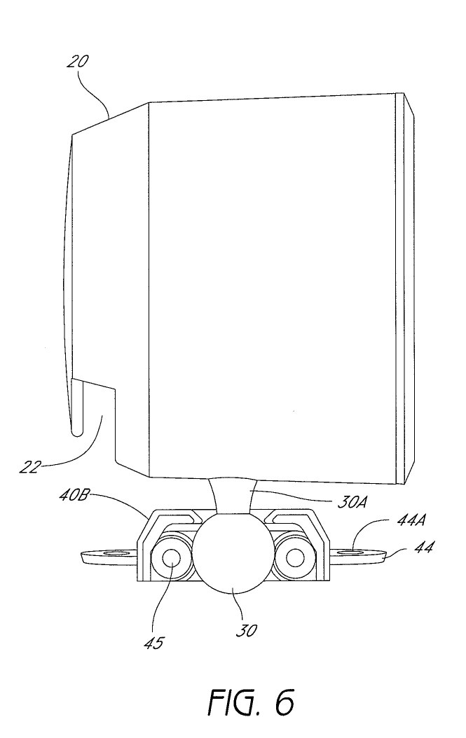

According to some embodiments, the ball joint housing 40 encases the ball joint 30. The ball joint housing 40 can include a base piece 40A (see FIG. 5) and a complementary joining piece 40B (see FIG. 6) that join together to form the ball joint housing 40 (see FIG. 7). One having ordinary skill in the art will appreciate that the base piece 40A and the joining piece 40B may be adapted to join together according to any known method, including a “snap fit” arrangement. In addition, the underside of the ball joint housing 40 may include a ball-shaped opening. The ball shaped opening allows a portion of the ball joint 30 to extend at least partially into the opening without interfering with the rotation or movement of the ball joint 30.

In some embodiments, as shown in FIGS. 5 and 6, the base piece 40A and joining piece 40B each include one or more openings 45, which when aligned, provide a clear passage for a securing mechanism, such as a screw, to secure the base piece 40A and joining piece 40B together to form the ball joint housing 40. A screw can be passed through the aligned openings 45 and secured in place by a nut.

In an embodiment of the inventions, the base piece 40A and joining piece 40B each include one or more securing tabs 44 for securing the ball joint housing 40 into the integration area 12 of the base 10. As illustrated in the embodiments of FIGS. 5-8, the securing tabs 44 include an opening 44A for allowing the passage of a screw or other known mechanical securing means. When the openings 44A of the securing tabs 44 of the pieces 40A, 40B are properly aligned, a slot is formed for accepting a securing mechanism, such as a screw, other fastener and/or the like.

In order to secure the cup 20 to the base 10, the ball joint housing 40 can be secured around the ball joint 30. In such embodiments, the cup 20 and ball joint housing 40 combination are then attached to the integration area 12 of the base 10 by fastening a screw or other fastener through the openings 44A and corresponding openings in the integration area 12. In one embodiment, the one or more screws attaching the cup 20 and ball joint housing 40 combination to the base 10 are further secured using one or more nuts. Furthermore, the integration area 12 may include a carved out or sunken region shaped, sized and otherwise configured to accommodate the ball joint housing 40. One of ordinary skill in the art will appreciate that the ball joint housing 40 may be connected to the base 10 via any known securing mechanism, such as, for example, a magnetic, adhesive, mechanical and/or other connection device, method or means. Embodiments of the cup 20 and ball joint housing 40 secured in the integration area 12 of the base 10 are illustrated in FIGS. 1, 3, 4 and 8C.

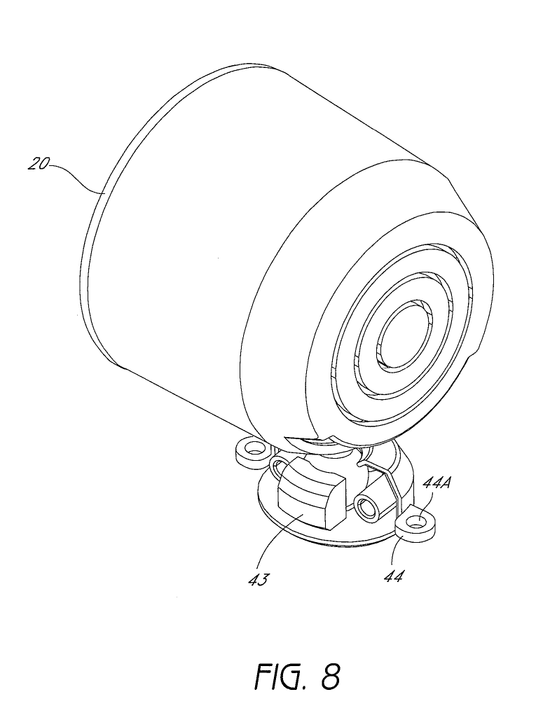

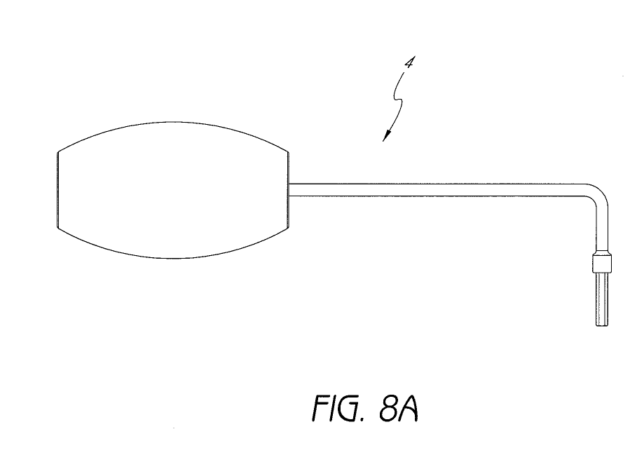

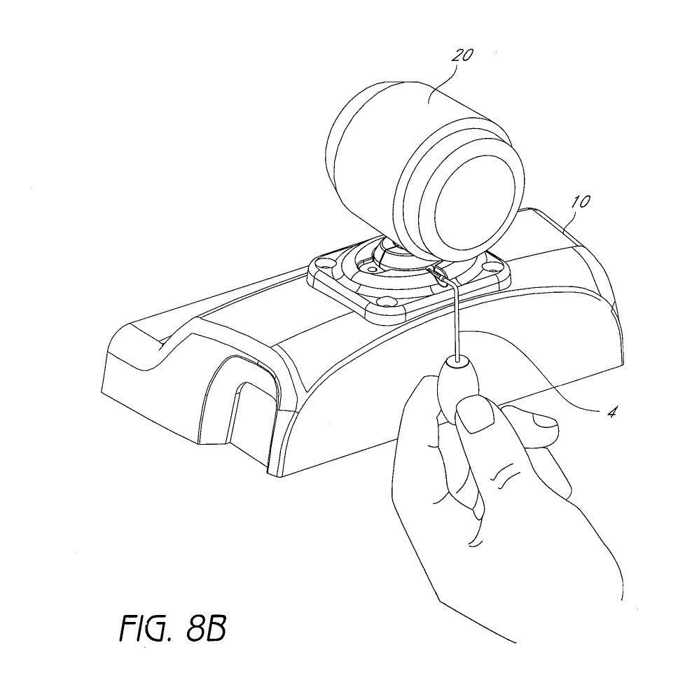

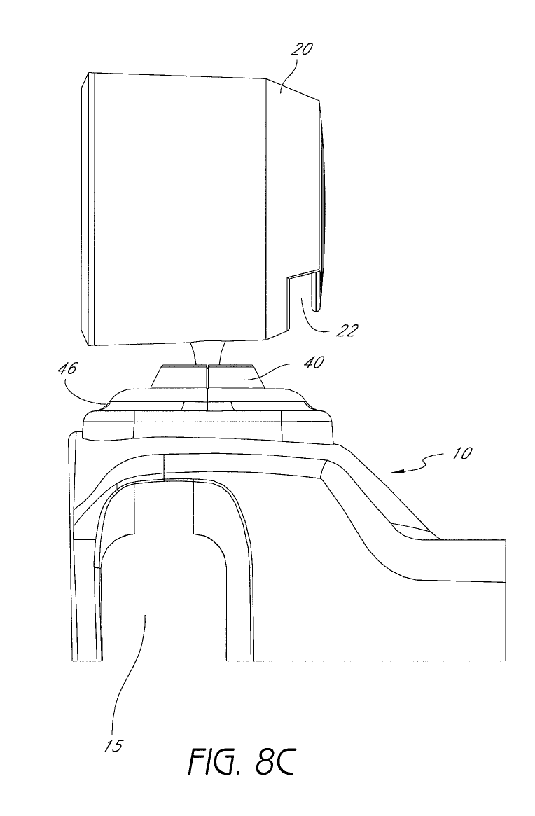

In an embodiment of the present inventions, the ball joint housing 40 includes a vice 42 which is configured to permit the tightening or loosening of the ball joint housing 40 around the ball joint 30. The vice 42 may be accessible via an outer side of the ball joint housing 40 and is operable by a known tool or key. In a preferred embodiment, the vice 42 is adjustable by a hex key, another type of key and/or any other mechanical device or method. An exemplary hex key 4 suitable for use with the pod device 1 is shown in FIG. 8A. According to the illustrated embodiment, the base 10 includes a vice key slot 46 that provides the operator with access to the vice 42, as shown in FIGS. 8B and 8C.

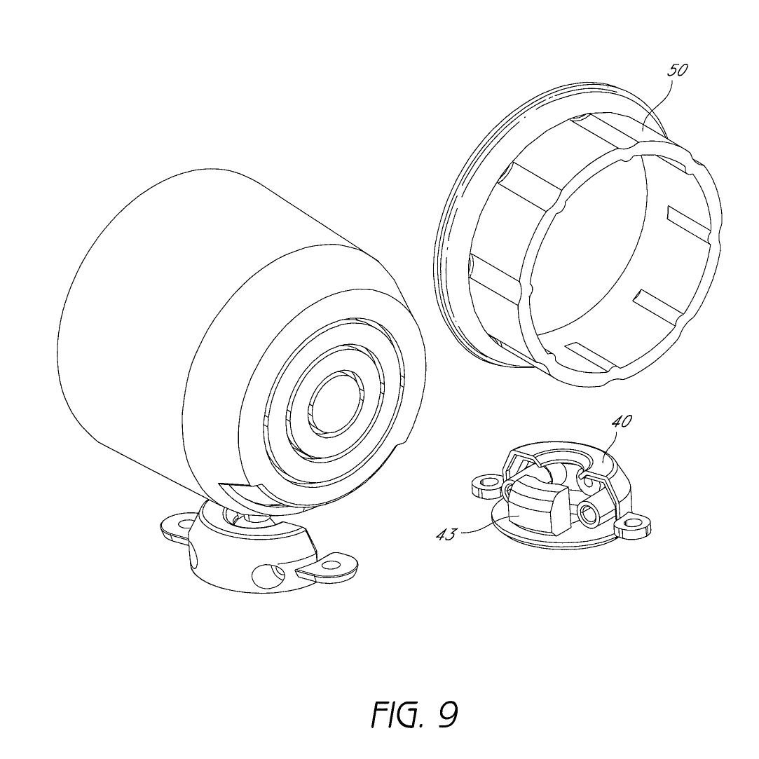

In addition, the ball joint housing 40 can include a capsule 43 (located in either the base piece 40A or the joining piece 40B), as illustrated in FIG. 9. In some embodiments, the capsule 43 is situated within the ball joint housing 40 such that the capsule 43 makes contact with the ball joint 30 when the ball joint housing 40 encases the ball joint 30. Further, the capsule 43 can be positioned between the vice 42 and the ball joint 30 such that contact between the vice 42 and capsule 43 may be made. According to some arrangements, the capsule 43 comprises one or more compliant material, such as, preferably, a rubber material. In a preferred embodiment, the capsule 43 includes a depression in its surface facing the ball joint 30 that is sized and shaped like the ball joint 30. One having ordinary skill in the art will appreciate that the capsule 43 may alternatively be included in the joining piece 40B, or both the base piece 40A and joining piece 40B may each include a capsule 43.

In operation, the operator places the vice key into the vice key slot 46 of the base 10 and engages the vice 42, as shown in FIG. 8B. To tighten the ball joint housing 40 around the ball joint 30, the key is turned, causing the vice 42 to move toward the ball joint 40. The vice 42 moves into contact with the capsule 43 which in turn makes contact with the ball joint 30. Moving the capsule 43 into contact with the ball joint 30 changes the amount of frictional force applied to the ball joint 30. As such, the position of the cup 20 may be fixed by tightening the vice 42 such that sufficient frictional pressure is applied to the ball joint 40 by the capsule 43 to prevent movement of the ball joint 30. Furthermore, the vice 42 may be set to apply sufficient frictional force to fix the position of the cup 20 against movement due to natural and/or unnatural forces such as gravity, the shaking, bouncing, vibrating and/or other movements of the vehicle. As such, the position of the cup 20 may be adjusted by hand.

Although the ball joint housing of the present invention is described as comprising two separate and adjoining pieces (40A and 40B), one having ordinary skill in the art will appreciate that the ball joint housing 40 may be one integral piece, with an important consideration being that it can accept and encase the ball joint 30. One having ordinary skill in the art will further appreciate that the ball joint housing 40 may be an integral part of the base 10 and the ball joint 30 may be integrally encased within the ball joint housing 40. Alternatively, the ball joint housing can include three or more separate and adjoining pieces, as desired or required by a particular application.

In some embodiments, the cup 20 may be fitted with a conversion sleeve 50, so named because it allows the diameter of the cup 20 to be converted to securely house any size gauge. The conversion sleeve 50 can be loaded into the front opening of the cup 20 and fit securely within the cup 20. For example, a conversion sleeve 50 may be fitted within the cup 20, thereby reducing the diameter of the cup 20 from one that securely fits a standard 60 mm gauge to one that securely fits a standard 52 mm gauge.

Exemplary conversion sleeves 50 are shown in FIG. 1. The conversion sleeve 50 may be composed of any compressible material, such as, for example, rubber, foam, etc. In a preferred embodiment, the conversion sleeve 50 is composed of rubber.

Like the fitment sleeve 25, a portion of the conversion sleeve 50 which is inserted into the cup 20 may include a textured outer surface. In some embodiments, the outer surface includes a plurality of raised and sunken ridges or slots 52 adapted to align with the arrangement of raised slots 21 of the cup 20 such that, upon proper alignment, the conversion sleeve 50 securely fits within the cup 20.

In addition, the interior surface of the conversion sleeve 50 can include a plurality of raised ribs or slots. According to some embodiments, the raised slots function much like the raised slots 21 arranged on the interior surface of the cup 20. The raised slots of the conversion sleeve 50 can provide friction against the gauge and can enable a secure fit of the gauge within the conversion sleeve 50.

One having ordinary skill in the art will appreciate that the conversion sleeve 50 ring may be sized such that it adapts the cup 20 to accept and fit any sized or shaped gauge. In addition, one of ordinary skill in the art will appreciate that the conversion sleeve 50 may be used in conjunction with conventional static pods or other commercially-available cup-like housings. For example, in some embodiments, the conversion sleeve 50 is fitted within a conventional 60 mm diameter gauge pod to convert the interior diameter of the pod to securely fit a standard 52 mm diameter gauge.

According to some preferred embodiments of the present inventions, the pod device 1 is manufactured using a conventional injection molding process. Injection molding provides a high quality and consistent end product. However, it will be appreciated that other molding processes, such as vacuum molding, blow molding, thermoforming, etc., can also be used.

According to another embodiment, the pod device 1 may be UV treated, according to known techniques, to prevent discoloration, sagging, and/or deformation of the pod device 1 due to sunlight, heat, moisture, other environmental conditions and/or the like. Further, it will appreciated that the pod device 1 can comprise one or more additional protective treatments and/or coatings, either in lieu of or in addition to the UV protection.

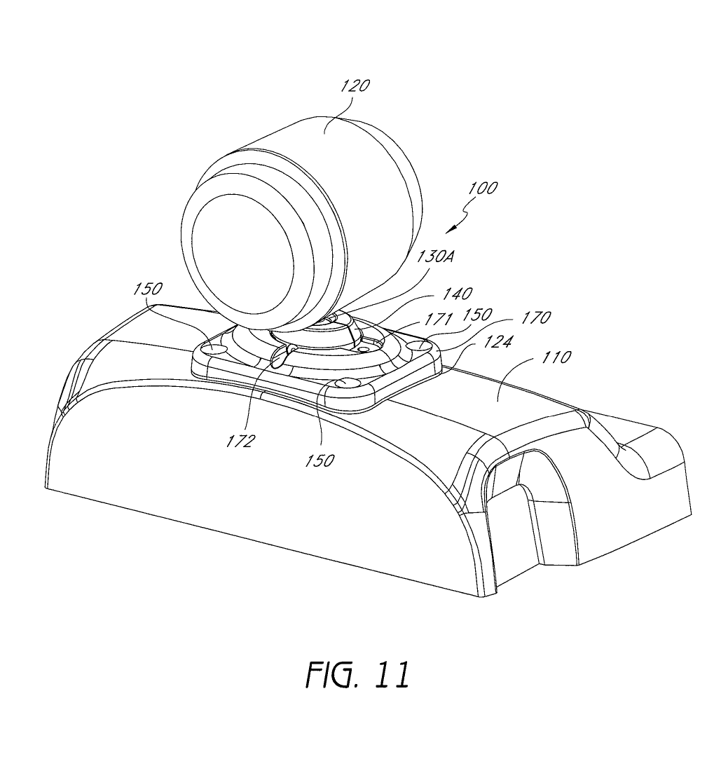

FIG. 11 illustrates a mounting device 100 according to another embodiment of the present inventions. The device 100 can comprise a base portion 124 and a housing 120, which in the illustrated embodiment is in the form of a cup. In the illustrated embodiment, the cup 120 can be configured as described above with reference to FIGS. 1-10. Accordingly, only certain aspects of the cup 120 will be described below and, for aspects omitted, reference may be made to the description above.

The cup 120 can be adapted to hold a display or other instrumentation, such as, for example, a gauge (an example of which is shown in FIG. 11). In one embodiment, the cup 120 can be composed of an plastic (e.g., ABS), fiberglass, metal and/or any other material. As described, the cup 120 can be dimensioned to accept and securely hold a gauge of any size (e.g., standard 52 mm and/or 60 mm gauges, other non-standard shapes or sizes, etc.). As shown in FIG. 11, a stem 130A can extend from the bottom side of the cup 120 so that the cup 120 can be positioned above or distanced from the base portion 124.

In certain embodiments, the cup 120 is modified or replaced with another device configured to hold or secure instrumentations (e.g., a gauge) to the stem 130. For example, the device 100 can include a C-shaped housing coupled to the stem 130. In another embodiment, the stem 130 is coupled (e.g., directly coupled, indirectly coupled, etc.) to the instrumentation.

With continued reference to the embodiment illustrated in FIG. 11, the ball joint 130 is located at an end of the stem 130A extending from the bottom side of the cup 20. In other embodiments, however, the ball joint 30 is connected directly to the bottom side of the cup 20.

In one embodiment, the ball joint 130 and the stem 130A are integral components of the cup 120 (i.e., the cup 120, the stem 130A and the ball joint 130 are machined or formed as a unitary piece). Alternative arrangements are contemplated, however, such as, for example, a separate composite piece, which comprises a stem 130A and ball joint 130, that is configured to attach to the cup 120.

With continued reference to FIG. 11, the mounting device 100 can be secured to an adjacent attachment surface 110 using a plurality of screws, other fasteners, other mechanical devices and/or the like. Accordingly, in the illustrated embodiment, the base portion 124 of the mounting device 100 includes a plurality of holes that allow the passage of one or more screws or other fasteners to the attachment surface 110. In other embodiments, the mounting device 100 is secured to an attachment surface 110 using other known attachment methods, non-limiting examples of which include gluing, riveting, welding, nailing, taping, snap fitting, slide fitting, bolting, suction fitting, and/or the like. Thus, the mounting device 100 can be quickly and easily secured to different attachment surfaces. Further, the mounting device 100 may be easily removed and/or relocated as desired.

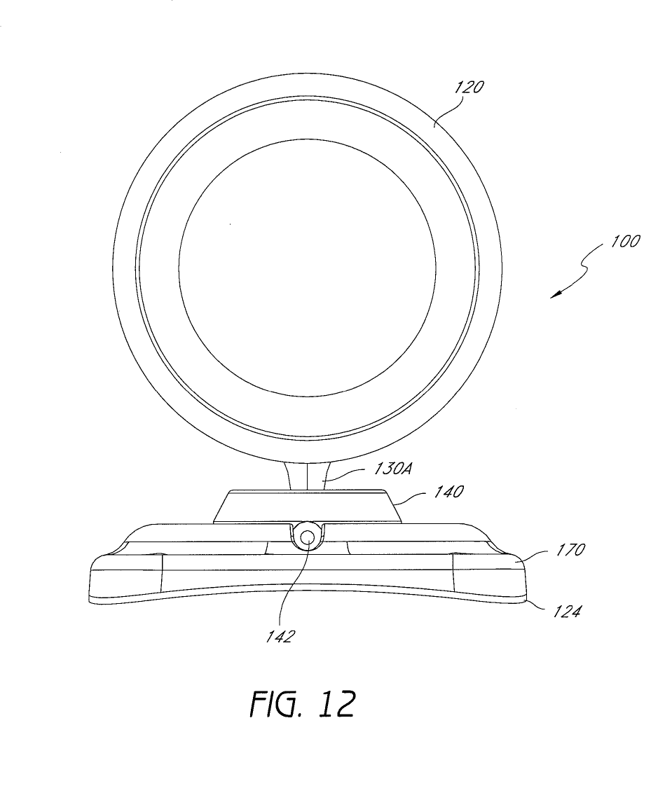

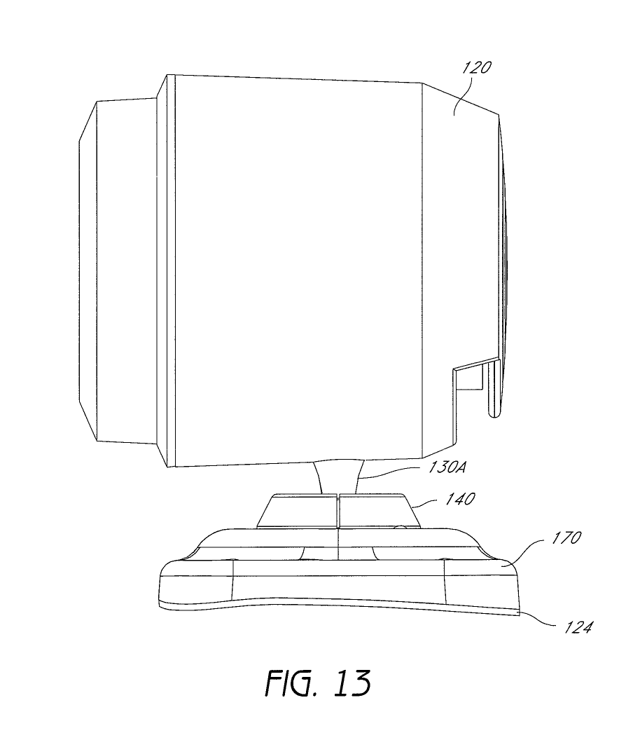

In some embodiments, as illustrated in FIG. 12, the bottom of the base portion 124 can have a generally curved (e.g., concave) shape for advantageously securing the mounting device 100 to a similarly shaped attachment surface. Likewise, a similar curvature to the bottom of the base portion 124 may also be provided along the other direction of the mounting device 100 (FIG. 13). However, the bottom surface of the base portion 124 can be flat or have any other shape. Further, a flexible gasket, shim, other compressible member and/or any other item can be provided between the mounting device 100 and the attachment surface 100 to compensate for any differences in the shape of the two surfaces.

With continued reference to FIGS. 12 and 13, the stem 130A can extend from the cup 120. Further, according to some embodiments, the stem 130A couples the cup 120 to the base portion 124. In certain embodiments, the cup 120 is pivotably attached to the base portion 124 using a ball joint 130 located beneath the stem 130A and within a ball joint housing 140.

In some embodiments, the ball joint 130 is adapted to fit within a ball joint housing 140. As described above, when in its non-fixed position within the ball joint housing 140, the ball joint 130 may be rotated to allow the cup 120 to rotate, swivel, tilt and/or move in one or more directions. The ball joint 130 can provide a wide range of motion and allow an operator to adjust the rotation angle and tilt of the cup 120. Advantageously, the cup 120 may be rotated freely 360 degrees, without limitation. Further, the cup 120 may be tilted in any manner desired, limited only by the physical structure of the device 100. Optionally, the ball joint housing 140 can be configured to enable the ball joint 130 a limited amount of lateral movement when in the non-fixed position. For example, movement of the cup position may be hand adjusted. Further, fine adjustments to the position of the cup 120 may be made by the operator. In certain embodiments, the cup 120 include a stem 130A with a ball-shaped joint at the end adapted to be encased in a ball joint housing 140. However, in alternative embodiments, other joint arrangements, of different types, shapes, sizes, etc., can be used given the consideration of permitting significant freedom in moving the cup 120.

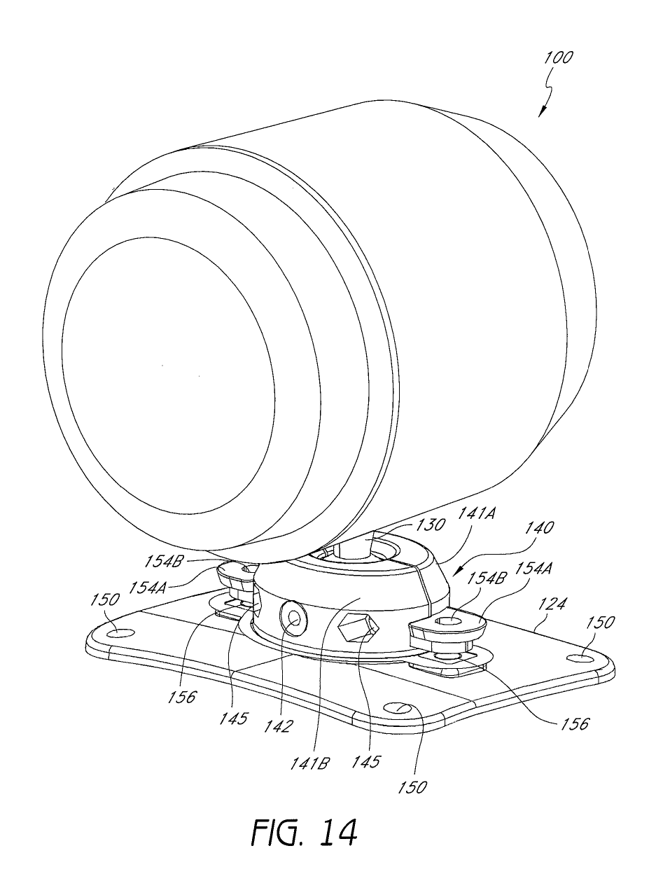

FIG. 14 illustrates one embodiment of the device 100 with a shell or cover 170 of the base portion 124 removed to expose the ball joint housing 140. With reference to FIGS. 11-13, the shell or cover 170 can be positioned over the base portion 124 to cover a portion of the ball joint housing 140.

With continued reference to the embodiment illustrated in FIG. 14, the ball joint housing 140 encases the ball joint 130. In the depicted embodiment, the ball joint housing 140 comprises a first portion 141A and a complementary second portion 141B that join together to form the ball joint housing 140. However, those of ordinary skill in the art will appreciate that the first portion 141A and the second portion 141B may be adapted to join together according to any known method, including a “snap fit” arrangement and/or the like. In alternative embodiments, the ball joint housing 140 can comprise more than two portions. In addition, the underside of the ball joint housing 140 may include a ball-shaped opening. The ball shaped opening can allow a portion of the ball joint 130 to extend at least partially into the opening, without interfering with the rotation or movement of the ball joint 130.

In the illustrated embodiment, the first and second portions 141A, 141B each include openings 145, which when aligned, provide a clear passage for a securing mechanism, such as a screw or, to secure the two portions 141A, 141B together to form the ball joint housing 140. In certain embodiments, a screw or other fastener is passed through the aligned openings 145 and secured in place by a nut.

With continued reference to FIG. 14, the ball joint housing 140 can include tabs 154A that are coupled to the first or second portions 141A, 141B. The tabs 154 can include vertically-oriented openings 154B. In some embodiments, the base portion 124 is configured to include corresponding openings 156 that accommodate the passage of connecting screws or other fasteners. In this manner, the shell 170 (not illustrated in FIG. 14) can be secured between the tabs 154B and the base portion 124. The shell 170, in turn, can include one or more recesses 171 for receiving the tabs 154B (see FIG. 11). Those of skill in the art will recognize, however, that other attachment methods or devices (e.g., adhesives, spot welds, rivets, etc.) may be used for any of the connections described herein.

In FIG. 14, the illustrated embodiment of the mounting device 100 includes a vice 142 which allows for the tightening and/or loosening of the ball joint housing 140 around the ball joint 130. In some preferred embodiments, a capsule (not shown) is situated between the vice 142 and the ball joint 130. Tightening of the vice 142 can cause the capsule to contact the ball joint 130. Continued tightening of the vice 142 can result in less or no mobility of the ball joint 130 within the ball joint housing 140. In the embodiment depicted in FIG. 11, the vice 142 is accessible via an outer side of the ball joint housing 140 through a groove 172 formed in the shell 170, and is operable by a known tool or key (e.g., the hex key shown in FIG. 8A or any other tool). In some embodiments, the vice 142 is adjustable by a hex key or other mechanical device. When the vice 142 is loosened, the ball joint 130 is capable of swiveling, allowing for easy adjustment of the position of the cup 120.

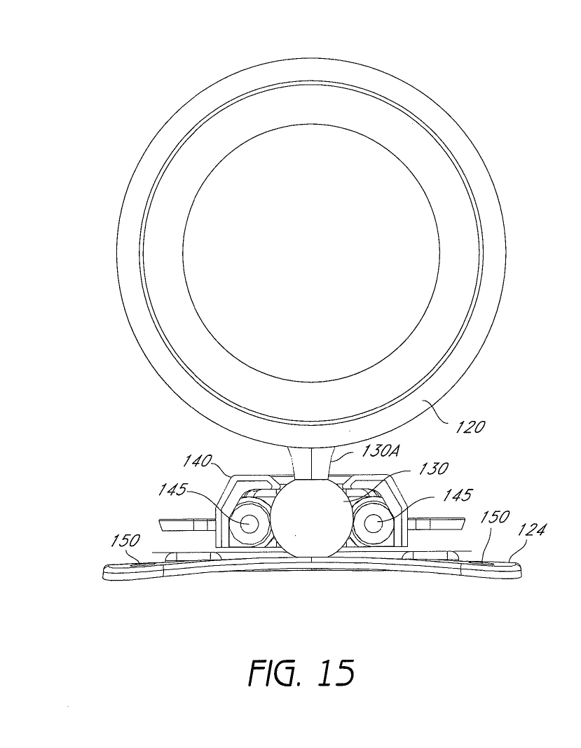

In other embodiments, as shown in FIG. 15, the ball joint 130 is prevented from moving laterally by the adjacent housings for the threaded openings 145. Thus, the threaded openings 145 can be strategically oriented to permit only rotational movement of the ball joint 130. However, it will be appreciated that one or more other methods of tightening and loosening the ball joint 130 may be provided. Further, as discussed, other types of joints that permit rotational movement can be used in lieu of or in addition to a ball joint. For example, swivel ball joints, a hinges, a universal joints, or the like can be used.

The base portion 124 of the mounting device 100 can be optionally configured with one or more cable drop zones for passage of one or more cables. In certain embodiments, the cable drop zone is located toward the rear of the mounting device so that it is non-visible or less visible when viewing the gauge or other instrument from the front. Those of skill in the art will also recognize that various other features of the pod device 1 described above or with reference to FIGS. 1-10 can also be integrated or substituted into the illustrated embodiments of FIGS. 11-15.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention. Thus, it is intended that the scope of the present invention herein disclosed should not be limited by the particular disclosed embodiments described above, but should be determined only by a fair reading of the claims that follow.

What is claimed is:

1. A device for mounting a gauge in a vehicle, the device comprising:
a base portion mountable to at least one surface in the vehicle; and
at least one housing coupled to the base portion,
wherein the housing is selectively positionable according to a viewer's preference and is configured to securely house a gauge.

2. The device of claim 1, wherein the at least one housing includes an adjustable ball joint.

3. The device of claim 2, wherein the ball joint is attached at an end of a stem, the stem extending from a bottom portion of the housing.

4. The device of claim 2, wherein the base further comprises a ball joint housing, the ball joint housing being adapted to encase the ball joint such that the ball joint is free to rotate within the ball joint housing.

5. The device of claim 4, wherein the ball joint housing includes a vice for tightening and loosening the ball joint housing.

6. The device of claim 5, wherein the ball joint housing includes a capsule, and wherein movement of the vice causes the capsule to move into and out of contact with the ball joint to provide an adjustable degree of frictional force to the ball joint.

7. The device of claim 1, wherein the housing comprises a cup.

8. The device of claim 7, wherein an interior surface of the cup includes a plurality of raised portions adapted to securely engage a gauge inserted within the cup.

9. The device of claim 7, further comprising a fitment sleeve adapted to fit within the cup, wherein the fitment sleeve being configured to allow the cup to secure gauges having varying tolerances.

10. The device of claim 9, wherein an exterior surface of the fitment sleeve comprises a plurality of raised portions adapted to align with the slots of the cup.

11. The device of claim 7, wherein the cup further comprises a cable feed slot, the slot configured to permit the passage of at least one gauge cable therethrough.

12. The device of claim 7, wherein the base portion includes at least one cable drop zone for the passage of one or more gauge cables.

13. The device of claim 7, wherein each cup includes a perforated rear wall delineating one or more removable sections.

14. The device of claim 1, wherein the housing is rotatable through 360 degrees.

15. The device of claim 1, wherein the housing is adapted to tilt.

16. The device of claim 1, further comprising a conversion sleeve adapted to fit within the housing, wherein the conversion sleeve is configured to allow the housing to secure a gauge of a smaller size than an originally intended gauge size.

17. The device of claim 16, wherein an interior surface of the conversion sleeve includes a plurality of raised portions adapted to securely engage a gauge inserted within the conversion sleeve.

18. The device of claim 1, wherein the base portion is mountable to the at least one surface in the vehicle using at least one mechanical fastener.

19. The device of claim 1, wherein the base portion is configured to be mountable to a dashboard area of the vehicle.

20. A method for displaying information in a vehicle, the method comprising the steps of:
securing a gauge for displaying vehicle information within a mounting device, the mounting device configured to permit the gauge to be rotated; and
securing the mounting device on a surface of the vehicle.

21. The method of claim 20, wherein the step of securing the mounting device on a surface of the vehicle comprises passing at least one fastener through a corresponding opening of the mounting device to engage a surface of the vehicle.

22. The method of claim 20, further comprising adjusting the position of the gauge secured within the mounting device by manipulating at least one joint of the mounting device.

23. The method of claim 22, wherein adjusting the position of the gauge comprises loosening and tightening a ball joint.
